(19) United States
(12) Patent Application Publication
(10) Pub. No.: US 2009/0070407 A1
(43) Pub. Date: Mar. 12, 2009

(54) SYSTEMS AND METHODS FOR SCHEDULING, PRODUCING, AND DISTRIBUTING A PRODUCTION OF AN EVENT

(75) Inventors: Gordon Castle, Atlanta, GA (US); Kevin Lee Hammond, Alpharetta, GA (US); Yonatan Amezene, Snellville, GA (US); Jeffrey Lynn Hall, Marietta, GA (US); Mathew J. Hathaway, Dacula, GA (US); Kevin James Garguilo, Duluth, GA (US); Jared Matthew Timmins, Adairsville, GA (US); David Lee Stevens, Atlanta, GA (US); David P. Deason, Tyrone, GA (US); Unni Vellanikaran, Atlanta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Turner Broadcasting System, Inc.

(21) Appl. No.: 11/851,039

(22) Filed: Sep. 6, 2007

(51) Int. Cl. G06F 15/16; G06F 3/048

(52) U.S. Cl. 709/203; 715/716

(57) ABSTRACT

According to various embodiments, an event management system is provided that provides a single interface through which a production team can schedule a production of an event, produce the production of the event, and direct distribution of the production. For example, in one embodiment, the event management system provides a web interface through which a member of the production team can create, or build an event, by specifying the name of the event, type of event, specific details about the event, whether the event will be broadcast live, and the date and time of the broadcast for the event. The event management system stores this information and provides at least a portion of it to a distributor that will be distributing (or broadcasting) the event to viewers. In addition, the event management system displays a pre-production checklist to guide the production team through the testing and production set-up process.

### BACKGROUND OF THE INVENTION

Production of an event has been a time-consuming and resource-consuming task. Typically, a member of a production team has to schedule the production with a distributor for distribution to viewers, which usually involves the member contacting the distributor and providing information about the production. In addition, prior to production, the event producer needs to arrange for production equipment to be transported to the event location, transmission paths for transmitting the production to viewers, staffing of the production team, and access to the venue for set up and testing of the production equipment prior to the event. During production, the team provides input into how the production is to be presented into one or more systems and directs how the production should be distributed using other systems or manual methods. The production team must also coordinate with the distributor(s) and coordinate event status (e.g., starting or stopping the live transmission of the event) and the delivery of the finished production for on-demand viewing.

Thus, a need in the art exists for a single system through which a production team can schedule, produce, and distribute a production of an event.

### BRIEF SUMMARY OF VARIOUS EMBODIMENTS OF THE INVENTION

Various embodiments of the invention provide an event management system for scheduling, producing, and distributing an event production. The system includes a memory and a processor, and the processor is configured for: (1) receiving a request to schedule a production of an event in advance of the event, the request including one or more event parameters uniquely identifying the event; (2) in response to receiving the request to schedule the production of said event, (a) notifying a distributor of the event such that the distributor is capable of scheduling a distribution of a production of the event, and (b) storing said one or more event parameters in said memory; (3) receiving from a user one or more instructions related to how at least a portion of the production of the event is to be displayed; (4) in response to receiving the one or more instructions, formatting the production according to the one or more instructions; (5) receiving instructions to start distributing the production; (6) in response to receiving the instructions to start distributing the production, directing the production to an encoder and a distribution server for distribution over a network; (7) storing the production to the memory; and (8) presenting a single interface through which the user provides the request to schedule the production of the event, the one or more instructions related to how the at least a portion of the production is to be displayed, and the instructions to start distributing the production. According to various embodiments, the production, which, for example, may be a live or pre-recorded (VOD) production, is distributed (or broadcast) over the Internet (e.g., via broadband), television, and/or cable systems.

According to another embodiment, an event management system is provided for creating a production of clips from an event representing highlights of the event. The event management system includes a processor and a memory, and the processor is configured for: (1) during production of the event, receiving input from a user indicating a portion of the production to be highlighted; (2) in response to receiving the input, associating a metadata tag with the portion of the production, wherein the metadata tag indicates a time the input is received; and (3) displaying the portions of the production to the user.

### BRIEF DESCRIPTION OF THE DRAWINGS

Having thus described the invention in general terms, reference will now be made to the accompanying drawings, which are not necessarily drawn to scale, and wherein:

FIG. 1 is a high-level block diagram of an event management system in accordance with various embodiments of the invention.

FIG. 2 is a block diagram of the components of an event management server in accordance with various embodiments of the invention.

FIG. 3 is a flow chart of a schedule builder module according to various embodiments of the invention.

FIG. 4 is a flow chart of an event production module according to various embodiments of the invention.

FIG. 5 is a flow chart of an event distribution module according to various embodiments of the invention.

FIG. 6 is a flow chart of a login sub-module according to various embodiments of the invention.

FIG. 7 is a flow chart of a highlights file module according to various embodiments of the invention.

FIG. 8 is an exemplary graphical user interface of an event management system according to one embodiment of the invention.

FIG. 9 is a partial view of an exemplary graphical user interface of a schedule builder interface according to one embodiment of the invention.

FIG. 10A is an upper portion of an exemplary graphical user interface of a create event interface according to one embodiment of the invention.

FIG. 10B is a lower portion of the exemplary graphical user interface of a create event interface shown in FIG. 10A.

FIG. 11 is a partial view of an exemplary graphical user interface of a change status interface according to one embodiment of the invention.

FIG. 12 is an exemplary graphical user interface of an event selection interface according to one embodiment of the invention.

FIG. 13 is an exemplary graphical user interface of a live stream control interface according to one embodiment of the invention.

FIG. 14 is an exemplary graphical user interface of an upload content interface according to one embodiment of the invention.

FIG. 15 is an exemplary graphical user interface of an event checklist interface according to one embodiment of the invention.

FIG. 16 is an upper perspective view of a scorebug device according to one embodiment of the invention.

FIG. 17 is an exemplary graphical user interface of a scorebug setup interface according to one embodiment of the invention.

FIG. 18 is an exemplary graphical user interface of a scorebug control interface according to one embodiment of the invention.

FIG. 19A is an exemplary graphical user interface of a live stream encoder selection interface according to one embodiment of the invention.

FIG. 19B is another view of the exemplary graphical user interface of a live stream encoder selection interface shown in FIG. 19A.

### DETAILED DESCRIPTION OF VARIOUS EMBODIMENTS OF THE INVENTION

Various embodiments of the present invention will now be described more fully with reference to the accompanying drawings, in which some, but not all embodiments of the invention are shown. Indeed, various embodiments of this invention may be embodied in many different forms and should not be construed as limited to the embodiments set forth herein. Rather, these embodiments are provided so that this disclosure will satisfy applicable legal requirements. Like numbers refer to like elements throughout.

As will be appreciated by one skilled in the relevant field in view of this disclosure, various embodiments of the present invention may be embodied as a method, a data processing system, or a computer program product. Accordingly, various embodiments of the present invention may take the form of an entirely hardware embodiment, an entirely software embodiment, or an embodiment combining software and hardware aspects. Furthermore, various embodiments of the present invention may take the form of a computer program product on a computer-readable storage medium having computer-readable program instructions (e.g., computer software) embodied in the storage medium. More particularly, various embodiments of the present invention may take the form of web-implemented computer software. Any suitable computer-readable storage medium may be utilized including hard disks, CD-ROMs, optical storage devices, or magnetic storage devices.

Various embodiments of the present invention are described below with reference to block diagrams and flowchart illustrations of methods, apparatuses (e.g., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### Brief Summary

According to various embodiments, the event management system provides a single interface through which a production team can schedule a production of an event, produce the production of the event, and direct distribution of the production. For example, the event management system provides a web interface through which a member of the production team can create, or build an event, by specifying the name of the event, type of event (e.g., sporting, play, festival, news), specific details about the event (e.g., women's soccer game between Clemson and Georgia Tech, a university's production of a play, a concert sponsored by a particular organization), whether the event will be broadcast live, and the date and time of the broadcast for the event. The event management system stores this information and provides at least a portion of it to a distributor that will be distributing the event to viewers.

In addition, the event management system displays a pre-production checklist to guide the production team through the testing and production set-up process. For example, the pre-production checklist prompts the user to test the equipment used during production (e.g., a live stream test if the production will be broadcast live, an encoder test, an Internet speed and connectivity test, and tests to ensure production equipment is communicating properly with the computer used at the production site to encode the production and transmit the production for distribution). In addition, the pre-production checklist prompts the user to set up parameters of various equipment based on the type of event production being recorded. For example, in one embodiment in which a sporting event is being produced, a score input device may be used to input the score into the event management system, and the score may be displayed in a scoreboard graphic superimposed on a portion of the video feed of the production. The user utilizes the event management system to specify the location of the scoreboard graphic, the teams displayed in the graphic, how the teams are represented in the graphic (e.g., text, stylized text, team logos or mascot images), and preview the scoreboard location and team representation selected. In addition, the event management system is used by the user to verify that the score input device works properly and is in communication with the event management system. Furthermore, the event management system allows the user to specify where an archive of the production should be stored.

When the production team is ready to start production of an event, a member of the team provides instructions to the event management system through a graphical user interface (GUI) to begin distribution of the event to viewers (e.g., by selecting an “On Air” button when the event is live) and/or provides instructions to begin archiving the event (e.g., by selecting a “Start Archiving” button). Similarly, the production team provides instructions to the event management system to stop distribution of the production (e.g., by selecting an “Off Air” button) and/or provides instructions to stop archiving the event (e.g., by selecting a “Stop Archiving” button).

After the event has been produced, the event management system can be used by the production team to upload the archived file storing the production to an event management server, upload metadata files to the event management server, and create and upload highlights files based on the production to the event management server. In addition, the event management system instructs the encoding software program, such as, for example, Windows Media Encoder, to transmit the encoded program to the correct server for distribution (broadcasting).

Having the ability to control the scheduling, equipment testing, production, and distribution from a single interface reduces the amount of time the production team spends setting up and producing an event and reduces the likelihood that the production team will encounter errors in the production or last minute technical difficulties that may affect the quality of the production, according to various embodiments of the invention. In addition, these advantages are further enhanced in a particular embodiment in which an event production kit, such as the event production kit described in co-pending U.S. patent application entitled Event Production Kit, assigned to the same assignee as this application and herein incorporated by reference in its entirety.

### System Architecture

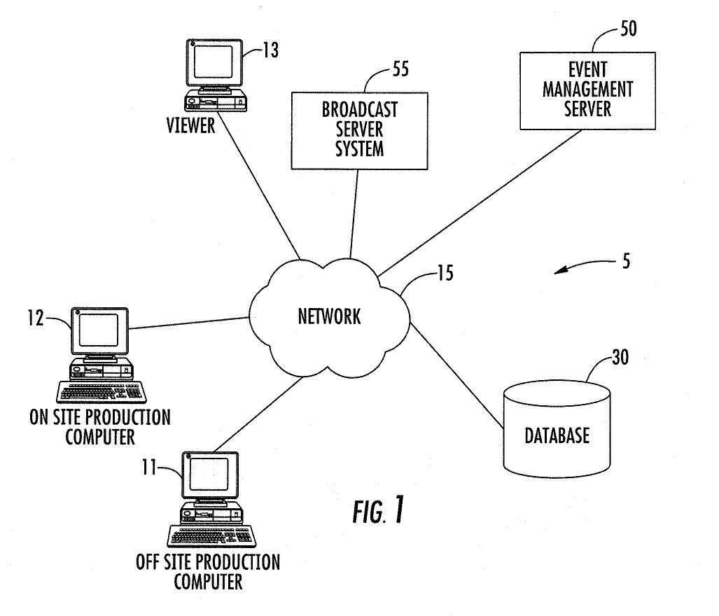

An event management system 5 according to one embodiment of the invention is shown in FIG. 1. As may be understood from this figure, in this embodiment, the system includes one or more computers 11, 12, 13 that are connected, via a network 15 (e.g., a LAN or the Internet), to communicate with an event management server 50. In a particular embodiment, the system 5 may also include a broadcast server system 55 that distributes an event program to viewers over the network 15, although in alternative embodiments, the event program may be distributed by the event management server 50. According to various embodiments, the broadcast server system 50 may comprise one or more servers. In a particular embodiment, the first computer 11 is a computer used by a member of the production team remotely from the site of the event to be produced, the second computer 12 is used by a member of the production team at the site of the event being produced and may include an encoder (e.g., Windows Media Encoder software), and the third computer 13 is associated with a viewer of the program produced. In one embodiment of the invention, the event production system 5 is configured for retrieving data from and storing data to a database 30 that may be stored on (or, alternatively, stored remotely from) the event management server 50.

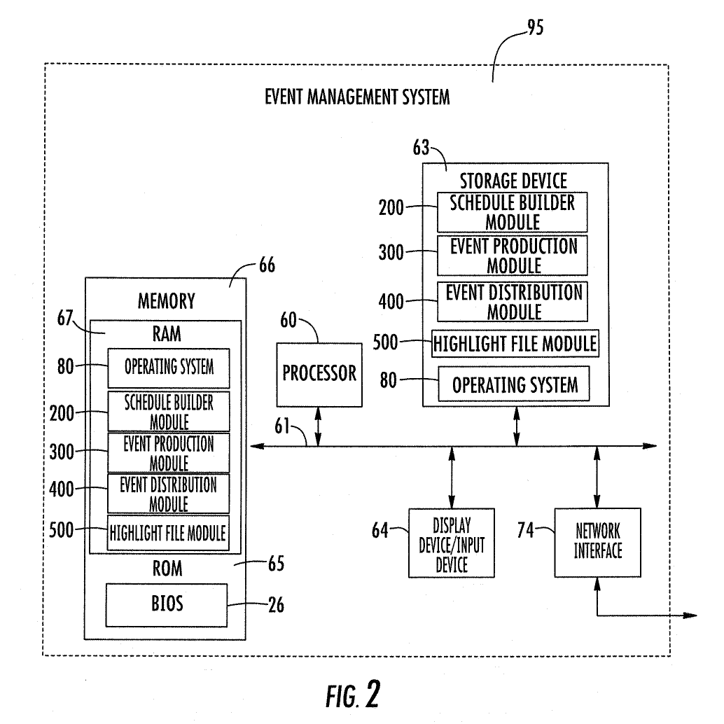

FIG. 2 shows a schematic diagram of an event management server 50 according to one embodiment of the invention. The event management server 50 includes a processor 60 that communicates with other elements within the event management server 50 via a system interface or bus 61. Also included in the event management server 50 is a display device/input device 64 for receiving and displaying data. This display device/input device 64 may be, for example, a keyboard or pointing device that is used in combination with a monitor. The event management server 50 further includes memory 66, which in one embodiment includes both read only memory (ROM) 65 and random access memory (RAM) 67. The server's ROM 65 is used to store a basic input/output system 26 (BIOS), containing the basic routines that help to transfer information between elements within the event management server 50.

In addition, according to one embodiment, the event management server 50 includes at least one storage device 63, such as a hard disk drive, a floppy disk drive, a CD-ROM drive, a DVR drive, or optical disk drive, for storing information on various computer-readable media, such as a hard disk, a removable magnetic disk, a DVR disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 80, a schedule builder module 200, an event production module 300, an event distribution module 400, and a highlights file module 500. The schedule builder module 200, the event production module 300, the event distribution module 400, and the highlights file module 500 control certain aspects of the operation of the event management server 50, as is described in more detail below, with the assistance of the processor 60 and an operating system 80. According to various embodiments, the modules 200, 300, 400, 500 are run from the event management server 50 when the computers 11, 12 are in communication with the event management server 50 over a network connection, such as the Internet or a private network. However in various other embodiments, local versions of the modules 200, 300, 400, 500 may be downloaded to computers 11, 12 to allow the user to manage production of the event offline and upload the selections and production at a later time.

Also located within the event management server 50 is a network interface 74, for interfacing and communicating with other elements of a computer network. It will be appreciated by one of ordinary skill in the art that one or more of the event management server 50 components may be located geographically remotely from other event management server 50 components. Furthermore, one or more of the components may be combined, and additional components performing functions described herein may be included in the event management server 50.

### Exemplary System Operation

According to various embodiments of the invention, the schedule builder module 200, the event production module 300, the event distribution module 400, and the highlights file module 500 allow the user to manage various aspects of the production of the event. In particular, the schedule builder module 200 allows a member of the production team to schedule the broadcast of the event prior to the event and set up various parameters of the program to be produced. The event production module 300 allows a member of the production team to test the production equipment and software, add special effects to the program to be broadcast, and control when the program is being broadcast and/or archived. The event distribution module 400 instructs the encoding software program to transmit the encoded production to the correct server for distribution over a network and archives the production according to the instructions provided by the production team. The highlights file module 500 creates a highlights file production of short clips taken from the full event production. Various embodiments of each module are described in more detail below.

Schedule Builder Module

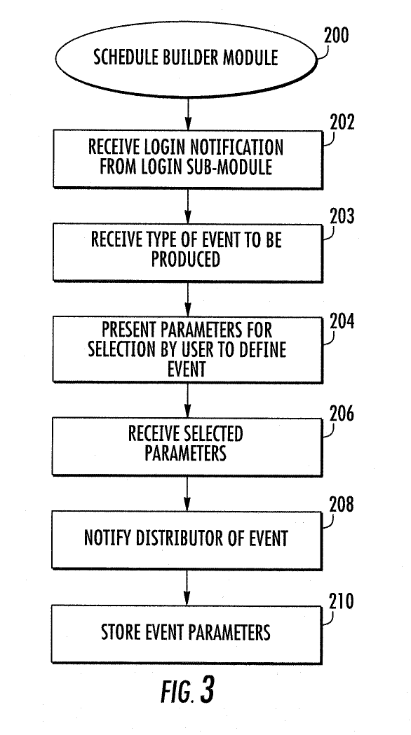

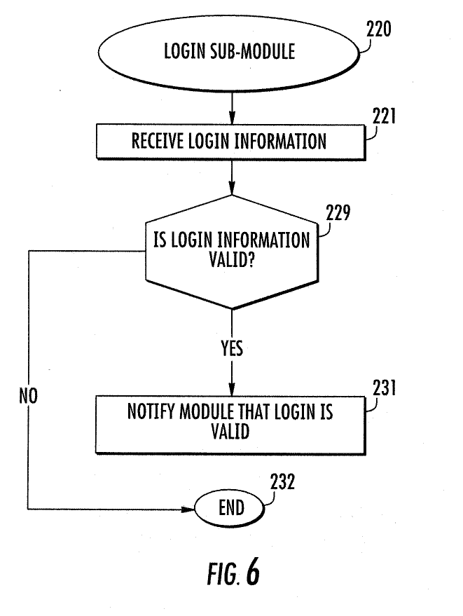

FIG. 3 illustrates an exemplary flow of a schedule builder module 200 according to various embodiments of the invention. Beginning at Step 202, the schedule builder module 200 requests the login sub-module 220 to authorize the user, which is discussed in relation to FIG. 6 below. If the user is authorized by the login sub-module 220, the schedule builder module 200 receives notification from the login sub-module 220. Possible users of the schedule builder module 200 may include a director, producer, an event manager, or a member of the production team, according to various embodiments of the invention.

At Step 203, the module 200 receives a type of event being produced (e.g., sporting, performance, festival). Depending on the type of event selected to be produced, the module 200 presents various parameters for selection by the user that further define specific details about the event, which is shown in Step 204. For example, if the type of event is a sporting event, the module 200 may request the user to input the teams playing in the game, the sport being played, the gender of the players, the location of the game, the date and time of the game, whether the game will be broadcast live, and a broadcaster of the game. According to one embodiment, “broadcaster” is used herein to refer to the entity that has the equipment used to produce the production of the event and provide the production for distribution to viewers. In another example, if the type of event is a performance (e.g., play, concert) or a festival, the module 200 may request the user to input the name of the performance or festival, the sponsor, the location, the date and time of the performance or festival, whether the performance or festival will be broadcast live, and the broadcaster of the event. In addition, the parameters may specify who will be allowed to view the event (e.g., privately viewed event or publicly available event). In Step 206, the module 200 receives the parameters selected by the user.

Next, in Step 208, the module 200 notifies the distributor of the event and provides to the distributor at least a portion of the parameters selected by the user in Step 206. Simultaneously, prior to, or after Step 208, the module 200 stores the event parameters in a memory 66 of the event management server 50, which is shown at Step 210.

After an event has been scheduled, the user can edit the parameters set in Step 206. If, for example, the user changes the distributor, the module 200 notifies the new distributor selected and the previously selected distributor of the change (not shown), according to one embodiment. In addition, the user can change the status of an event. To facilitate a change in the status, the module 200 receives a request to change the status of the event, and in response, presents the current status to the user (not shown). If the user selects a new status, this new status is received and stored by the module 200 (not shown). According to one embodiment, the types of status include cancelled (e.g., indicating that the event has been cancelled and will not be broadcast), completed (e.g., indicating the event is over and the production has been completed, delayed (e.g., indicating that the event has been delayed from the scheduled start time), deleted (e.g., indicating that the production is no longer stored on the system), interrupted (e.g., indicating that the production has been interrupted), live now (e.g., indicating that the production is currently being broadcast live), scheduled (e.g., indicating that the production is scheduled to be broadcast but has not yet started), video on demand unavailable (e.g., indicating that the production will not be available for viewing after the event is over), and video on demand uploading (e.g., indicating that the production is being uploaded to the system and will be available for viewing).

Event Production Module

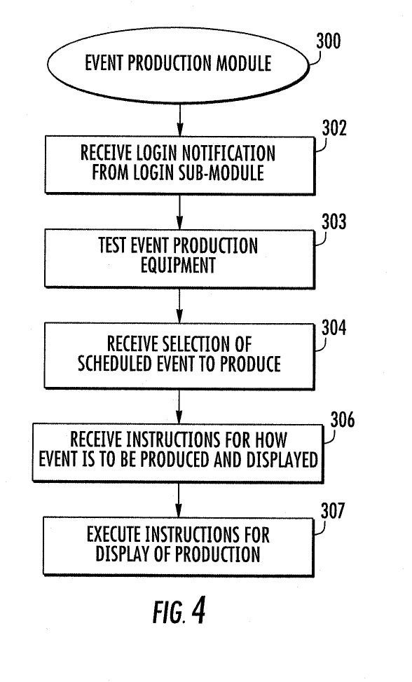

FIG. 4 illustrates steps executed by an event production module 300 according to various embodiments of the invention. Beginning at Step 302, the event production module 300 requests the login sub-module 220 to authorize the user, which is discussed in relation to FIG. 6 below. If the user is authorized by the login sub-module 220, the event production module 300 receives notification from the login sub-module 220.

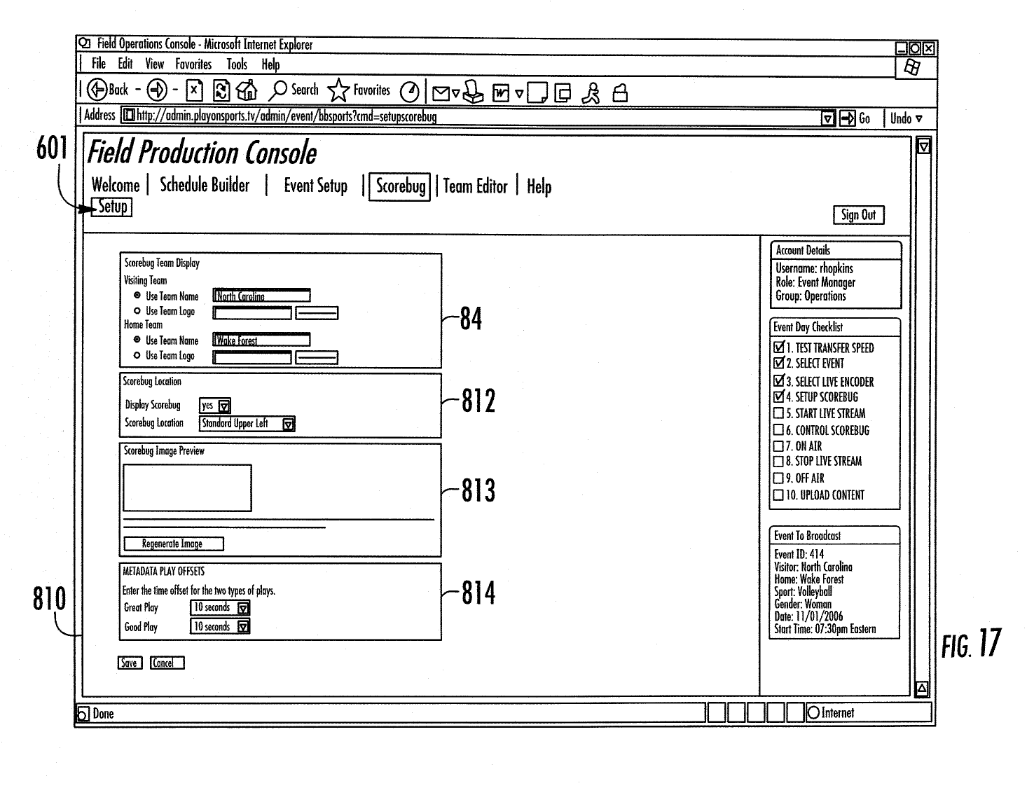

Next, in Step 303, the module 300 prompts the user to test one or more pieces of production equipment to be used in producing the event. For example, in one embodiment, the module 300 prompts the user to test the connectivity of the network (e.g., the Internet or other wide area network, a private network) over which the production will be sent for distribution, the speed of the network connection, and whether peripheral devices, such as an event-specific input device, which is described below in relation to FIGS. 16 through 18, is communicating with the production computer 12. In one embodiment, the speed of the network connection is tested by sending the user to a third party website that tests connection speed, such as, for example, www.wugnet.com/myspeed/speedtest.asp.

After the equipment has been tested and is confirmed to be functioning properly, the event to be produced is selected by the user, and this selection is received by the event production module 300, as shown in Step 304. In a particular embodiment, the user may select the event from a list of events that have been pre-scheduled using the schedule builder module 200. Upon selecting the event, at least a portion of the parameters defining in the event are retrieved and presented to the user for verification (not shown).

Next, the event production module 300 receives instructions from one or more members of the production team regarding how the selected event is to be produced and displayed to viewers, which is shown in Step 306. In one embodiment, the user may select a graphic to display over a portion of the video feed of the production. For example, this graphic may be a scoreboard if the event produced is a sporting event, subtitles if the event produced is an opera or a performance in a foreign language, a news by-line, or an identifier for the person, group, or place being featured in the production. The selection of the graphic by the user may further include providing instructions as to where the graphic should be displayed (e.g., upper right corner, upper left corner, bottom right corner, bottom left corner, along the bottom side, along the top side, etc.) and what should be displayed in the graphic. For example, in the embodiment in which the graphic is a scoreboard, the user may select how the identities of the teams playing are to be displayed (e.g., using the team names, team nicknames, or logos) and which team is the home team and which team is the visiting team. In embodiments in which the teams' logos are selected for display, the user may choose a .jpeg or .tiff file storing the logo for display according to a particular embodiment.

In another embodiment, the user may select a graphic, referred to herein as a “full-screen slate”, to be displayed in lieu of the video feed for the production. The full-screen slate may be displayed to provide a display prior to the beginning of the broadcast of the production (instead of a blank screen, for example). In addition, the full-screen slate may be used to communicate a rain or weather delay, communicate halftime or an intermission, or communicate that the system is having technical difficulties. To select the graphic to be used as the full-screen slate, according to one embodiment, the user selects a file containing the graphic (e.g., .jpeg or .tiff file). When distribution of the production is to begin or restart, the user may provide instructions to the event production module 300 to remove the full-screen slate. Next, as shown in Step 307, the event production module 300 executes the instructions provided in Step 306 for the production display, and the production is displayed according to the instructions provided in Step 306.

Event Distribution Module

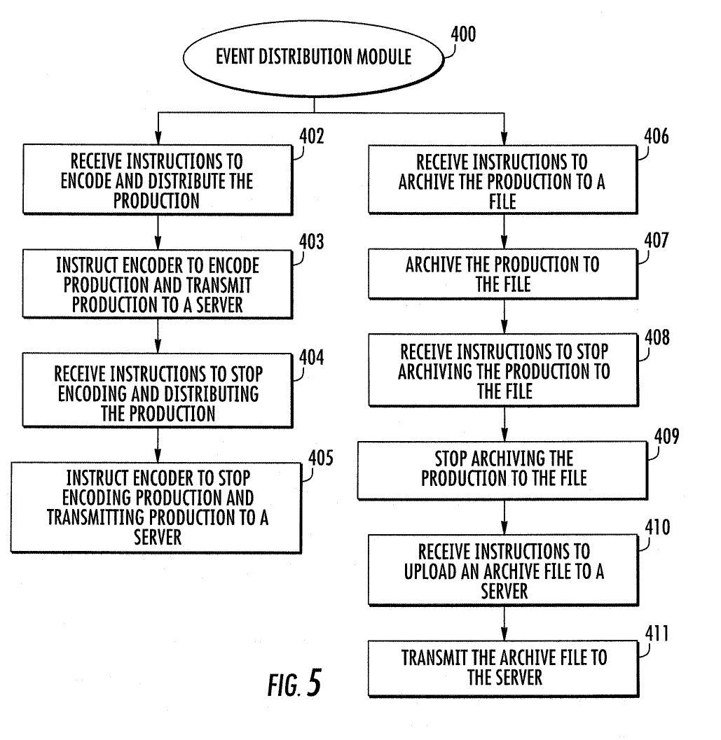

The event distribution module 400 directs the encoding and distribution of the production, the archiving of the production, and the uploading of the archive file to the event management server 50. FIG. 5 illustrates steps executed by an event distribution module 400 according to various embodiments of the invention. In particular, at Step 402, the event distribution module 400 receives instructions from the user to encode and distribute the production. In response, the module 400 instructs an encoding software program, such as, for example, Windows Media Encoder, to transmit the encoded production to a particular server for distribution (broadcasting), which is shown in Step 403. For example, in various embodiments, the server distributing the production may be the event management server 50 or the broadcast server system 55. When the user wants to stop distribution of the production, such as during intermission or halftime of a game or when the event is over, the module 400 receives instructions from the user to stop encoding and distribution of the production, as shown in Step 404. In response, the module 400 instructs the encoding software program to stop encoding and distribution of the production, as shown in Step 405.

In addition, the event distribution module 400 receives instructions from a user to archive the production to a file stored locally on the production computer 12, which is shown in Step 406. In response, the module 400 stores the production to a file located on the production computer 12, which is shown in Step 407. The location and name of the file may be specified by the user prior to the beginning the production, according to one embodiment. When the user wants to stop archiving the production, such as during intermission or halftime of a game or when the event is over, the module 400 receives instructions from the user to stop archiving the production, as shown in Step 408. In response, the module 400 stops archiving the production, as shown in Step 409.

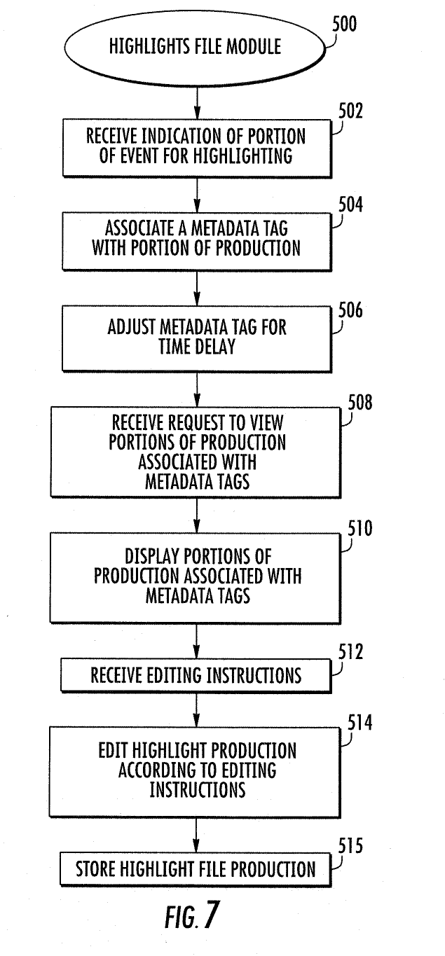

Next, the event distribution module 400 receives instructions from a user to upload an archive file related to the production to a server, shown as Step 410. For example, in one embodiment, the instructions may include the name (path) of the archive file, the type of production saved to the archive file, the intended file location on server 50, and an “upload” instruction. For example, the type of production may include the event file (e.g., the full production of the event), a teaser file (e.g., production of short clips of the event that do not include clips of the end of the production), a highlights file (e.g., production of short clips from the event that may include clips of the end of the production), and a metadata file (e.g., file storing time code values associated with portions of the production). Embodiments of how a highlights file and a metadata file may be created are discussed below in relation to FIG. 7. In response to receiving instructions to upload the archive file, the module 400 transmits the archive file to the specified file location, which is shown as Step 411. In one embodiment, the archive file is sent using file transfer protocol (FTP) over the Internet to the appropriate server location. In other various embodiments (not shown), the archive file of the production is created and stored on the event management server 50 or the broadcast server system 55.

Highlights File Module

FIG. 7 illustrates steps executed by a highlights file module 500 according to various embodiments of the invention. Beginning at Step 502, the highlights file module 500 receives input from the user indicating a portion of the event that may be worth highlighting, such as a good or great play in a sporting event or a particular scene in a play or festival. In response to receiving the input, the module 500 associates a metadata tag with the portion of the production being recorded at the time the input is received, which is shown as Step 504. In one embodiment, the module 500 receives a time delay for the metadata tag (e.g., 0 seconds, 5 seconds, 10 seconds) and the length of time for the portion of the program to be associated with the metadata tag (e.g., 15 seconds, 20 seconds, 30 seconds) from the user (not shown). When a time delay and length of time for the program are set, the metadata tag is adjusted to be associated with the portion of the production corresponding to the time at which the input is received minus the time delay, which is shown as Step 506, and the length of the program associated with the metadata tag corresponds with the length of time set by the user.

Next, the module 500 receives a request from the user to view the portions of the production associated with the metadata tags (called “highlight clips”), which is shown in Step 508, and in response, the module 500 displays the highlight clips for viewing by the user, shown as Step 510. In a particular embodiment, the highlight clips are presented in temporal order to the user. The user can then select which highlight clip, if any, the user does not want included in a highlight program production, and the user can adjust the beginning and end of each clip. These editing instructions are received by the highlights file module 500 in Step 512, and the highlights file module 500 edits the production according to these instructions in Step 514. The highlights file module 500 stores the highlights file production in Step 515.

According to various embodiments of the invention, the input provided to the highlights file module 500 may be provided through an event-specific input device (e.g., the “scorebug” described in relation to FIGS. 16 through 18) and/or through a keyboard and/or mouse coupled to the computer 12.

Login Sub-Module

FIG. 6 illustrates an exemplary flow of a login sub-module 220 according to one embodiment of the invention. Beginning at Step 221, the login sub-module 220 receives login information from the user via a dialog window displayed by the system. The system then advances to Step 229, where the login sub-module 220 evaluates the received login information to determine whether the login information is valid (e.g., by determining whether the login information corresponds to that of a valid user within the database). If the login information is not valid, the user may attempt to re-enter the login information. If the login information is valid, the login sub-module 220 notifies the module requesting login authorization that the login was successful at Step 231, and the login sub-module 220 ends at Step 232.

Exemplary Graphical User Interfaces

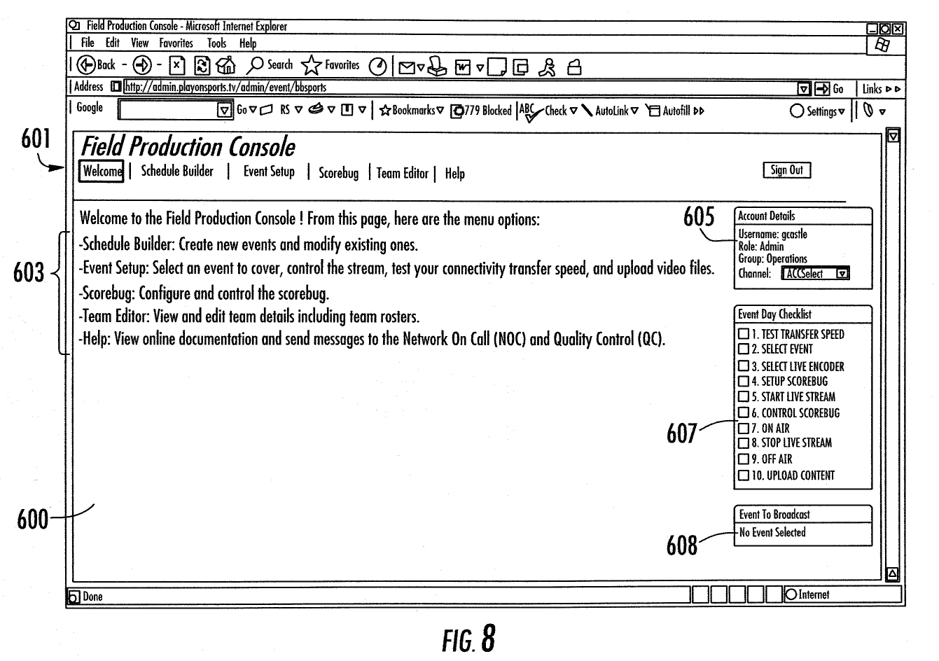

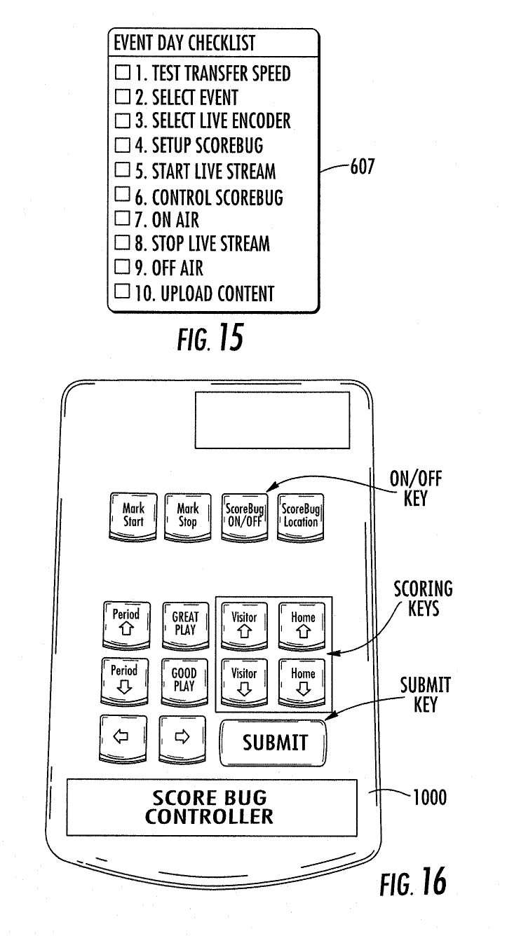

Various embodiments of the system 5 provide an event management graphical user interface (GUI) through which the user can provide instructions to the various modules 200, 300, 400, 500 and view parameters previously set by the user related to the production. In one embodiment, which is shown in FIG. 8, a welcome interface 600 is displayed to the user that presents options for managing various aspects of the system 5. The welcome interface 600 provides a main menu 601 presenting various management options for the user's selection in the upper portion of the screen, and below the main menu 601 is displayed a sub-menu 603 of options related to the selected option in the main menu 601. Exemplary options displayed in the main menu 601 include a welcome link, a schedule builder link, an event setup link, a team editor link, and a help link. The welcome interface 600 further displays details of the user logged into the system 5 in an account details window 605, an event day checklist window 607 that includes hyperlinks to items to be done prior to and/or during the production of an event (an embodiment of the checklist is described in relation to FIG. 15 below), and a window 608 displaying whether an event has been selected for production.

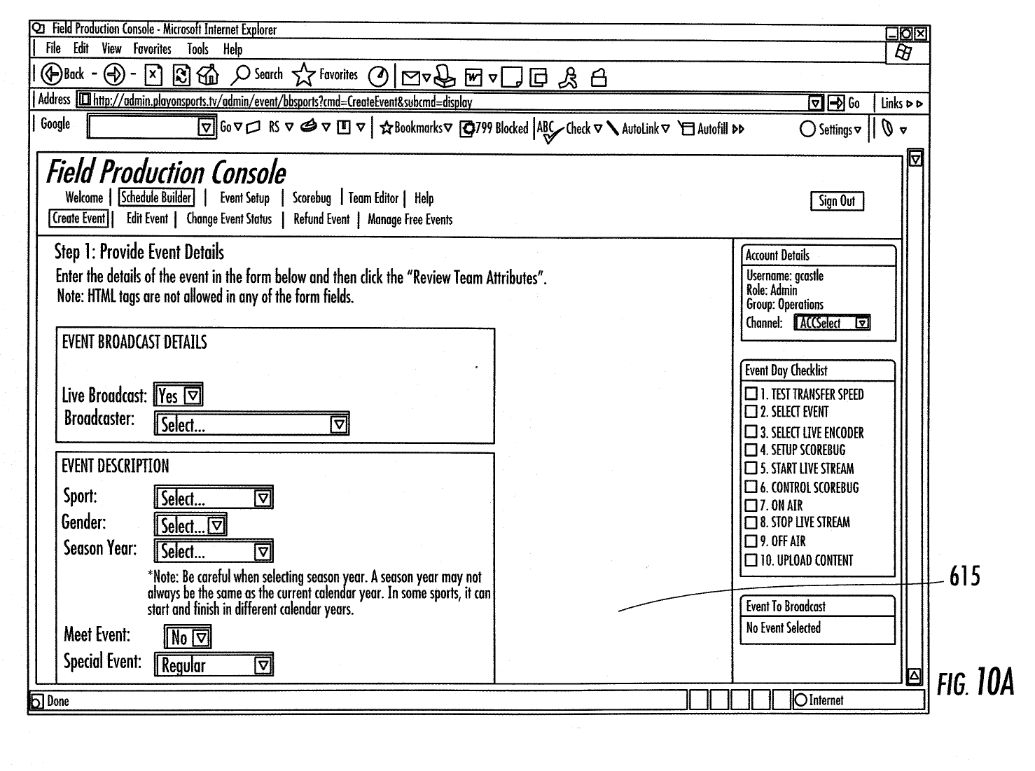

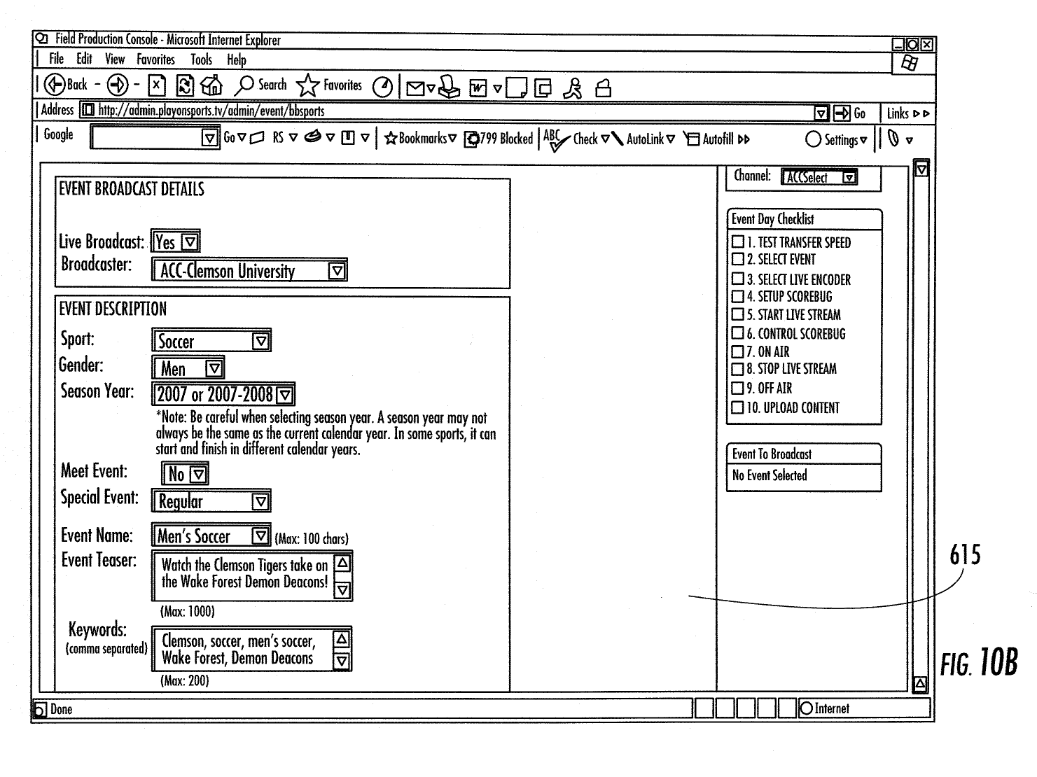

According to one embodiment of the invention, when the schedule builder link is selected, a schedule builder interface is displayed, such as the partial view of the schedule builder interface 610 shown in FIG. 9. As shown in FIG. 9, the schedule builder interface 610 displays a sub-menu 611 that displays the sub-options of creating an event, editing an event, and changing the status of an event. For example, in one embodiment, if the user chooses to create an event, a create event interface, such as the create event interface 615 shown in FIGS. 10A and 10B, is displayed. The create event interface 615 provides various text boxes and drop down boxes to receive input from the user indicating the parameters used to define and schedule the production of the event. The input received by this interface 615 may be provided to the schedule builder module 200 as described above in relation to FIG. 3, according to various embodiments of the invention. In particular, according to the embodiment shown in FIGS. 10A and 10B, the parameters presented by the create event interface 615 include whether the event will be broadcast live or on demand, the broadcaster of the event, the sport to be played, the gender of the players, the season in which the event will be played, whether the event is a meet event (e.g., more than two teams will be participating), whether the event is a special event (e.g., tournament, regular season play), a name identifying the event (e.g., chosen by the user), an event teaser which may be used to advertise the event, and keywords describing the event which may be used to enable potential viewers to search for the event. Although not shown, the create event interface 615 may also request the user to verify that the user has rights to produce the event.

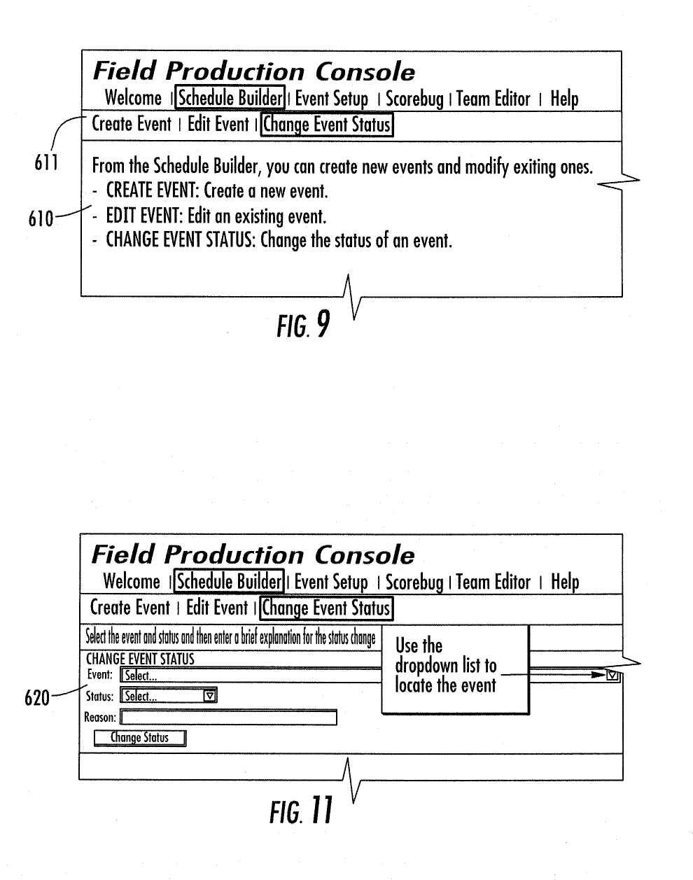

As another example, in one embodiment, if the user chooses to change the status of an event, a change event status interface, such as the partial view of the change event status interface 620 shown in FIG. 11, is displayed. The change event status interface 620 provides drop-down boxes to allow the user to select the event and the new status for the selected event. In addition, the change event status interface 620 provides a text box for receiving a reason from the user as to why the status has been changed. The information entered in the change event status interface 620 is received by the schedule builder module 200 to update the status of the event.

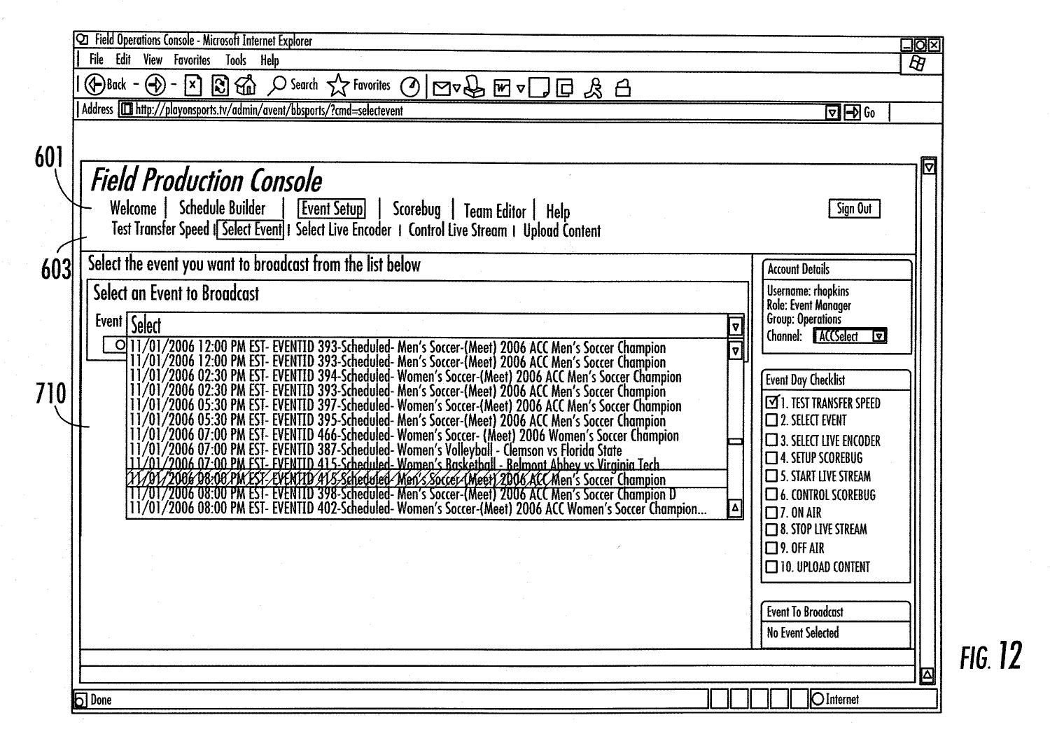

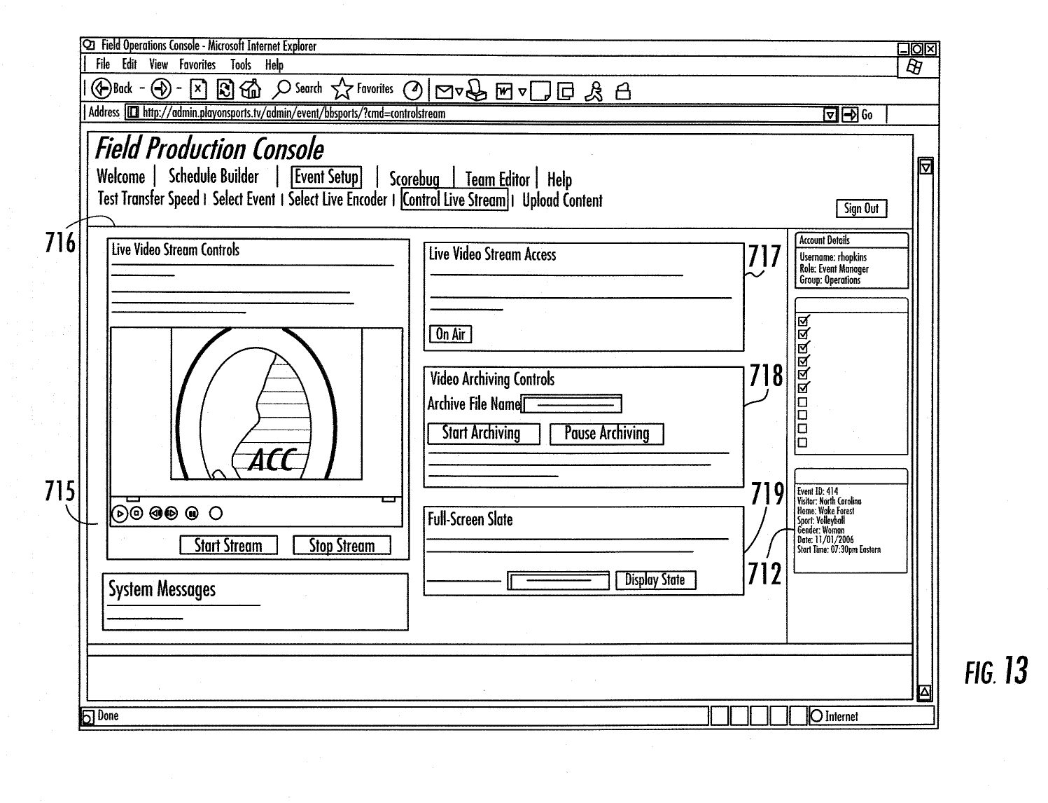

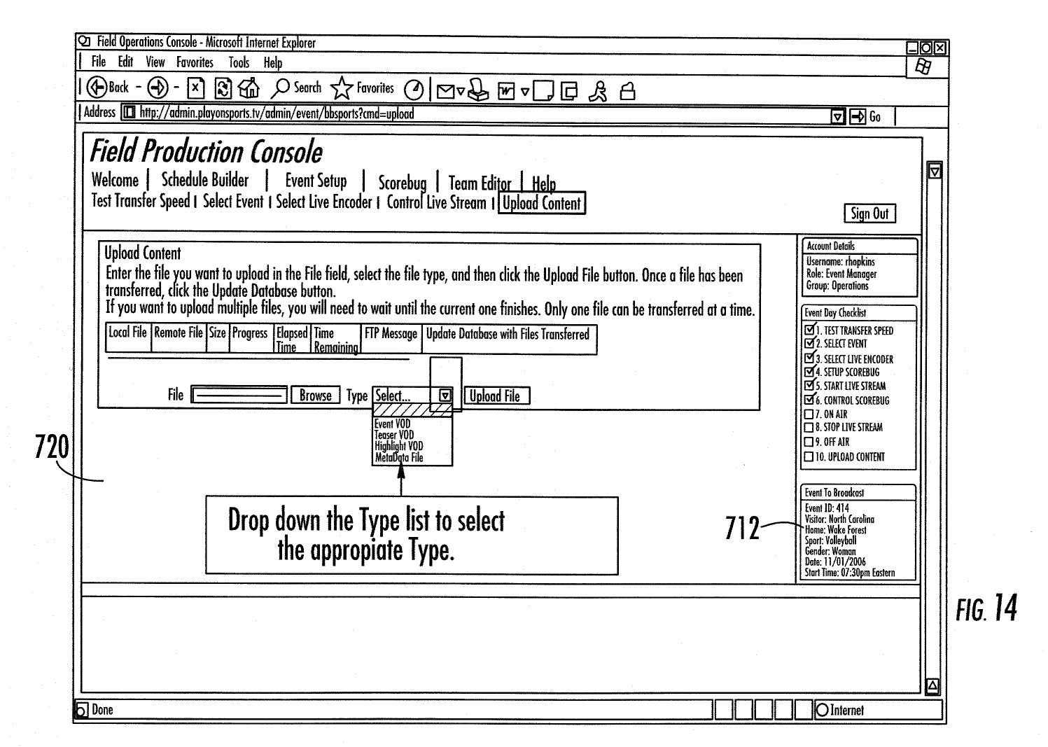

According to one embodiment, when the event setup link is selected from the menu 601, the sub-menu 603 displays links to the options of testing the transfer speed of the local computer 12, selecting the event to be produced, selecting a live encoder for encoding the production, controlling the live stream, and uploading content to the event management server 50. For example, if the user selects the link to select the event to be produced, a select event interface is displayed. An exemplary select event interface 710 according to one embodiment is shown in FIG. 12. The select event interface 710 provides a drop-down box listing scheduled events from which the user can select the event to be produced. This selection is received by the event production module 300, which is described above in relation to FIG. 4. Upon selection of the event, a listing of one or more parameters defining the event may be displayed to the user in an event parameters window 712, as shown in FIGS. 13 and 14. By displaying the event parameters to the user, the user can check the parameters before production of the event begins to determine whether any of the parameters need to be changed to reflect any changes since the event was originally scheduled.

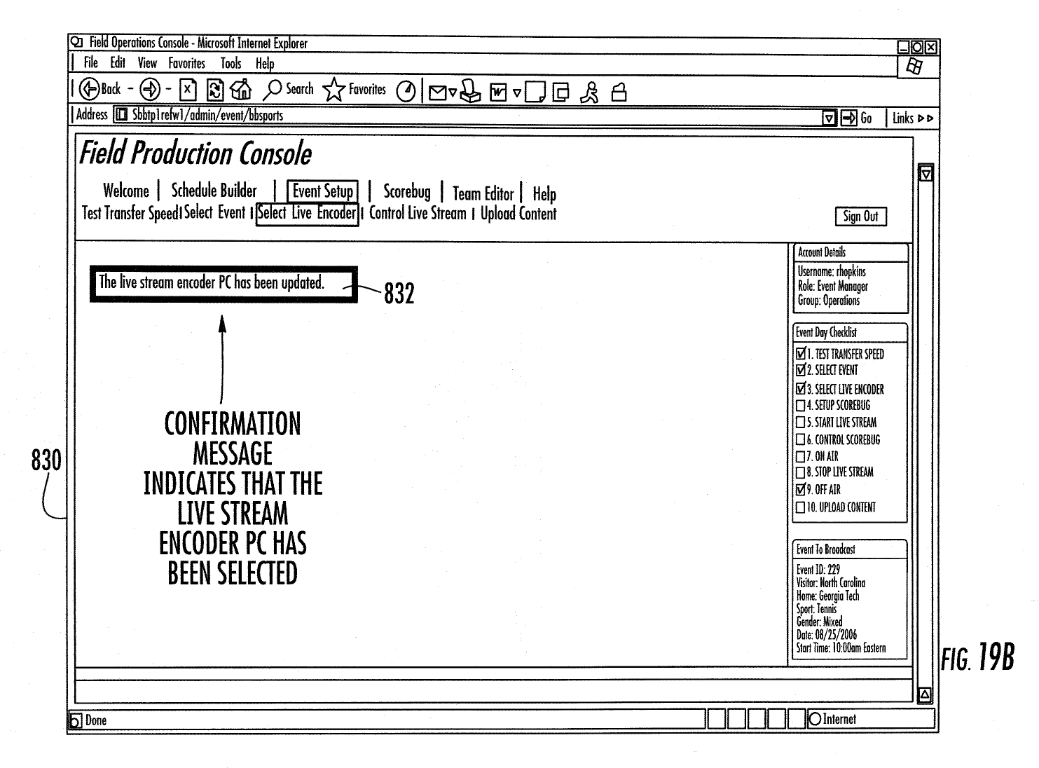

In another example, if the user selects the link to select a live encoder for encoding the production, an interface is displayed that allows the user to select a computer to use for encoding the live stream. An exemplary live stream encoder selection interface 830 is shown in FIGS. 19A and 19B. In particular, if a computer for encoding the live stream has not been selected, the exemplary live stream encoder selection interface 830 displays a window 831 that includes a drop down box listing the encoder computers available for selection, as shown in FIG. 19A. The user selects the appropriate encoder computer from the drop down box listing, and this input is received by the event production module 400, which is described above in relation to FIG. 4. Once a computer for encoding the live stream has been selected, the live stream encoder interface 830 displays a message 832 that the computer selected for encoding the live stream has been selected, as shown in FIG. 19B.

As another example, if the user selects the link to control the live stream, an interface is displayed that allows the user to view the live stream, select whether to start or stop the live stream, select whether to distribute the live stream (“on air”), select whether to archive the live stream, and/or select whether to display a full-screen slate. An exemplary live stream control interface 715 according to one embodiment is shown in FIG. 13. For example, the live stream control interface 715 includes a live video stream controls window 716 for displaying the live video stream and presenting buttons to toggle starting and stopping the stream. The interface 715 further includes a live video stream access window 717 that presents an “On Air” button to allow the user to instruct the event distribution module 400 to begin streaming of the production to viewers. After the “On Air” button is selected, an “Off Air” button (not shown) is presented in the window 717 that allows the user to instruct the event distribution module 400 to stop streaming. In addition, the interface 715 includes a video archiving controls window 718 that allows the user to input a file name to which the production should be archived and to instruct the event production module 400 to start and stop archiving by selecting the “Start Archiving” button or the “Pause Archiving” button. Furthermore, the interface 715 includes a full-screen slate window 719 that allows the user to specify a file name of an image to be displayed as the full-screen slate and to instruct the event production module 300 when the full-screen slate should be displayed by selecting the “Display Slate” button.

In yet another example, if the user selects the upload content link, an upload content interface is displayed. An exemplary upload content interface 720 according to one embodiment is shown in FIG. 14. The upload content interface 720 provides a text box and browse feature that allows a user to select the file to be uploaded to the event management server 50 from the local computer 11, 12 and a drop-down box that allows the user to select the type of file being uploaded. This input is received by the event distribution module 400 to direct uploading of files to the server 50, which is described above in relation to FIG. 5.

In addition, when the event setup link is selected from the menu 601, a checklist is displayed in each of the interfaces related to event setup, according to various embodiments of the invention. For example, FIG. 15 illustrates an embodiment of the event checklist window 607 to be displayed. The checklist guides the user through the event setup process to ensure that the production equipment is working properly and the appropriate steps have been taken to produce the event. In one embodiment, the checklist highlights items that need to be done prior to other items on the list and may make items that are not ready to be done unavailable for selection by the user. For example, in the embodiment shown in FIG. 15, the user can select items 1 through 3 to perform the steps of testing the transfer speed, selecting the event, or selecting the live encoder, respectively, but the user cannot select the remaining items until one or more of items 1 through 3 have been completed. As a particular item is completed, the interface includes a checkmark in the box adjacent the item and highlights and/or makes available for selection other items that can be done upon completion of the particular item. Other items included on the checklist, according to the embodiment shown in FIG. 15, include starting the live stream, starting distribution of the live stream (“On Air), stopping the live stream, stopping distribution of the live stream (“Off Air”), and uploading content.

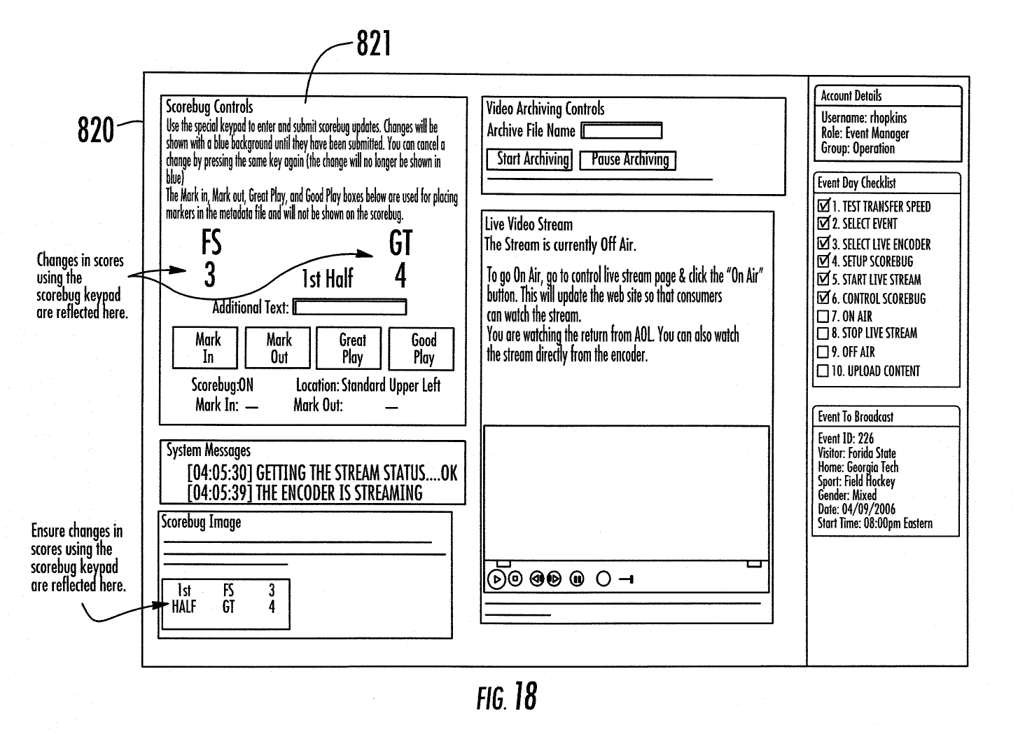

Furthermore, as shown in the embodiment in FIG. 15, when the event is a sporting event, the checklist may also display the options of setting up a “scorebug”, which is an input device that receives scoring input from the user, and controlling the scorebug. An exemplary embodiment of the scorebug device 1000 is shown in FIG. 16. The scorebug device 1000 allows the user to input whether the score of the home team or the visitor team should be adjusted up or down and whether the period of play in the event should be adjusted up or down, for example. The options of setting up and controlling the scorebug device 1000 may also be available to the user by selecting the scorebug link in the menu 601, according to one embodiment. When the user selects the option of setting up the scorebug device 1000, a scorebug setup interface is displayed, such as the scorebug setup interface 810 shown in FIG. 17. The scorebug setup interface 810 provides various text boxes and drop down boxes to allow the user to input the name or logo of the teams playing, indicate whether each team is the home team or the visiting team and preview the image of a scoreboard to be displayed. For example, the interface 810 displays a scorebug team display window 811 in which the user can input the name of the teams or a file name for a logo associated with the teams and whether the team is the home team or the away team, a scorebug location window 812 in which the user can select whether to display the scoreboard graphic associated with the use of the scorebug device and the location of the scoreboard graphic on the video feed, and a scorebug image preview window 813 in which the user can view the scoreboard graphic based on the information input in windows 811 and 812. This input is received by the event production module 300, which is described above in relation to FIG. 4.

In addition, in one embodiment, the scorebug setup interface 810 provides a metadata play offsets window 814 in which drop down boxes are displayed to allow the user to select an offset time delays for highlight inputs. These time delays are received by the highlights file module 500, which is described above in relation to FIG. 7. For example, as described above in relation to FIG. 7, the scorebug device 1000 includes a button for indicating “good plays” and a button for indicating “great plays”. When the user selects one of these buttons, the input is sent to the highlights file module 500, and any time delay setup in the metadata play offsets window 814 of the scorebug setup interface 810 is used by the highlights file module 500 to offset the portion of the production clip to be associated with the metadata tag.

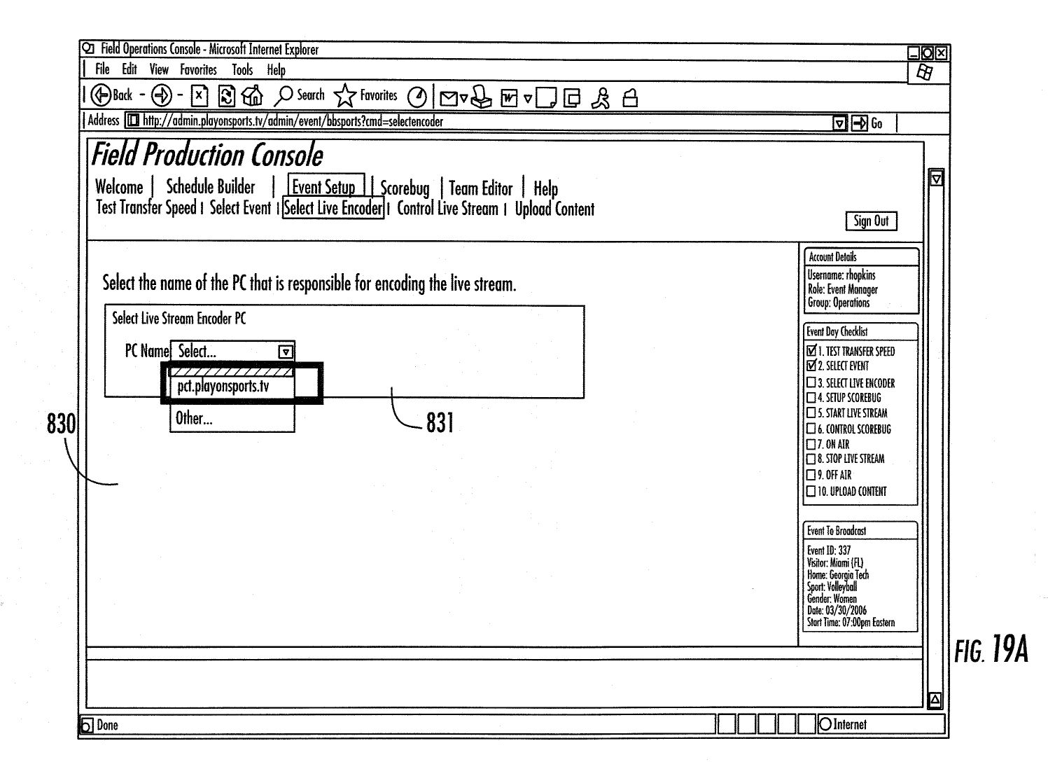

When the user selects the option of controlling the scorebug, a scorebug control interface is displayed that displays input received from the scorebug to verify that the scorebug is communicating with the local computer 12. For example, the scorebug control interface 820 shown in FIG. 18 includes a scorebug controls window 821 in which changes in the scores using the scorebug device 1000 are being displayed, indicating that these changes have been received by the computer 12.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

1. An event management system for scheduling, producing, and distributing a production of an event, said system comprising a memory and a processor, said processor configured for:
receiving a request to schedule a production of an event in advance of said event, said request comprising one or more event parameters uniquely identifying said event;
in response to receiving said request to schedule said production of said event, notifying a distributor of said event such that said distributor is capable of scheduling a distribution of a production of said event;
in response to receiving said request to schedule said production of said event, storing said one or more event parameters in said memory;
receiving from a user one or more instructions related to how at least a portion of said production of said event is to be displayed;
in response to receiving said one or more instructions, formatting said production according to said one or more instructions;
receiving instructions to start distributing said production;
in response to receiving said instructions to start distributing said production, directing said production to an encoder and a distribution server for distribution over a network;
storing said production to said memory; and
presenting a single interface through which said user provides said request to schedule said production of said event, said one or more instructions related to how said at least a portion of said production is to be displayed, and said instructions to start distributing said production.

2. The event management system of claim 1 wherein said one or more event parameters uniquely identifying said event is selected from one or more of: a sport to be played, a gender playing said sport, a date to be played, a time to be played, a location to be played, a home team to play, a visiting team to play, or whether said event is live or pre-recorded.

3. The event management system of claim 1 wherein notifying said distributor of said event comprises transmitting said one or more parameters to said distributor over a network.

4. The event management system of claim 1 wherein said network is the Internet.

5. The event management system of claim 1 wherein said one or more instructions related to how said at least a portion of said production of said event is to be displayed comprise an instruction to display a scoreboard overlaid on a video feed portion of said production.

6. The event management system of claim 5 wherein said one or more instructions related to how said at least a portion of said production of said event is to be displayed further comprise identities of teams participating in said event.

7. The event management system of claim 5 wherein each of said identities of teams comprises a team logo.

8. The event management system of claim 5 wherein each of said identities of teams comprises a team name.

9. The event management system of claim 1 wherein said one or more instructions related to how said at least a portion of said production of said event is to be displayed comprises an instruction to display a full-screen slate.

10. The event management system of claim 9 wherein said instruction to display a full-screen slate comprises an identity of a file storing an image to be displayed.

11. The event management system of claim 9 wherein said full-screen slate indicates a broadcaster, a delay in said event, an intermission in said event, or technical difficulties in displaying said production.

12. The event management system of claim 1 wherein said one or more instructions related to how said at least a portion of said production of said event is to be displayed comprise an instruction to remove a full-screen slate.

13. The event management system of claim 1 wherein said processor is further configured for receiving instructions to stop distributing said production, and in response to receiving said instructions to stop distributing said production, directing said encoder to stop encoding said production for distribution over said network.

14. The event management system of claim 1 wherein said processor is further configured for receiving an instruction to start storing said production to a local memory, said local memory being remotely located from said memory of said event production system, and in response to receiving said instruction to start storing said production to said local memory, storing said production to said local memory.

15. The event management system of claim 14 wherein said processor is further configured for receiving an instruction to stop storing said production to said local memory, and in response to receiving said instruction to stop storing said production to said local memory, ceasing to store said production to said local memory.

16. The event management system of claim 14 wherein said memory is remotely located from said user, and wherein storing said production to said memory comprises uploading said production from said local memory to said remotely located memory.

17. The event management system of claim 16 wherein storing said production to said memory further comprises identifying a type for said production, said type being selected from one of: a full event, a teaser, a highlight, or a metadata file.

18. The event management system of claim 1 wherein said processor is further configured for:
receiving a request to test one or more pieces of event production equipment;
in response to receiving said request, testing said one or more pieces of event production equipment.

19. The event management system of claim 18 wherein said processor is further configured for:
in response to testing said one or more pieces of event production equipment and receiving a response that at least one piece of said event production equipment is not operating correctly, presenting one or more instructions to a user to troubleshoot said at least one piece of event production equipment.

20. The event management system of claim 1 wherein said processor is further configured for receiving a request to change a status of said event, said status of said event being selected from one of: cancelled, completed, delayed, deleted, interrupted, live, scheduled, video on demand unavailable, or video on demand being uploaded.

21. The event management system of claim 1 wherein said processor is further configured for receiving a request to edit said one or more parameters of said event after said one or more parameters have been stored in said memory.

22. An event management system for creating a production of clips from an event, said clips representing highlights of said event, said event management system comprising a processor and a memory, said processor configured for:
during production of said event, receiving input from a user indicating a portion of said production to be highlighted;
in response to receiving said input, associating a metadata tag with said portion of said production, said metadata tag indicating a time said input is received; and
displaying said portions of said production to said user.

23. The event management system of claim 22 wherein said time said input is received comprises an offset of an amount of time pre-selected by said user prior to production.

24. The event management system of claim 22 wherein said production of said clips comprises said portions of said production associated with said metadata tags.

25. The event management system of claim 24 wherein said processor is further configured for receiving a request to increase or decrease a length of time represented by at least one of said portions of said production associated with said metadata tags.
